(19) United States
(12) Patent Application Publication
(10) Pub. No.: US 2025/0185836 A1
(43) Pub. Date: Jun. 12, 2025

(54) Electric Food Preparation Appliance

(71) Applicant: SEB S.A., Ecully (FR)

(72) Inventors: Romain Turpin, Ecully Cedex (FR); Philippe Dumoux, Ecully Cedex (FR)

(73) Assignee: SEB S.A., Ecully (FR)

(21) Appl. No.: 18/977,211

(22) Filed: Dec. 11, 2024

(30) Foreign Application Priority Data
Dec. 11, 2023 (FR) 2313949

(51) Int. Cl. A47J 27/08; A47J 27/086; A47J 37/06

(52) U.S. Cl. CPC A47J 27/0806; A47J 27/0802; A47J 27/0813; A47J 27/086; A47J 37/0641

(57) ABSTRACT

An electric preparation appliance includes at least:
a housing with a supporting portion arranged to rest on a workspace and defining a base plane,
a lid, which can be moved between a closed position in which access to the workspace is prevented and an open position in which access to the workspace is permitted,
means of locking the lid, which can be moved between an unlocked position in which the lid can be freely moved, and a locked position in which the lid is locked in the closed position,
a control interface, which can be moved between a first control position and a second control position,
characterized in that the control interface comprises a handle that rotates around a handle axis contained in a plane parallel to the base plane.

### CROSS-REFERENCE TO RELATED APPLICATIONS

This application claims priority from French application number 2313949, filed Dec. 11, 2023, the disclosure of which is hereby incorporated herein by reference.

### TECHNICAL FIELD OF THE INVENTION

The present invention generally relates to an electric food preparation appliance capable of operating in several cooking modes, including at least one pressure cooking mode and at least one hot-air cooking mode.

### STATE OF THE ART

Electric food preparation appliances capable of operating in several cooking modes are common in the prior art. The various modes can be chosen by a user on a human-machine interface located on the housing and the lid is locked by toggling a front selector switch around a vertical axis between three positions. On the other hand, the selector switch is necessarily moved by the user's fingers alone, which can only transmit limited forces, particularly when the switch is toggled around a vertical axis. Moreover, in an environment in which the user is likely to handle greasy substances, a front selector switch can be difficult to grip. Thus, there may be situations in which the choice of a front selector switch as the control interface for a food preparation appliance requires the user to use both hands, as the cooking appliance itself is ergonomically limited.

### DISCLOSURE OF THE INVENTION

One purpose of the present invention is to address the aforementioned drawbacks of the prior art and, in particular, to provide an electric food preparation appliance featuring a control interface comprising a handle that rotates around a horizontal axis.

To this end, a first aspect of the invention relates to an electric food preparation appliance designed to operate in a plurality of cooking modes, including at least one pressure cooking mode, comprising at least:
a housing with a supporting portion designed to rest on a worktop and defining a base plane,
a compartment, arranged in the housing,
a container defining a workspace for holding food for preparing the dish and designed to be accommodated in the compartment in the housing,
a lid, which can be moved between a closed position in which access to the workspace is prevented and an open position in which access to the workspace is permitted,
means of locking the lid, which can be moved between an unlocked position in which the lid can be freely moved between the closed position and the open position, and a locked position in which the lid is locked in the closed position so as to enable said at least one pressure cooking mode,
a control interface, which can be moved between a first control position in which the locking means are in their locked position and a second control position in which the locking means are in their unlocked position, characterized in that the control interface comprises a handle that rotates around a handle axis contained in a plane substantially parallel to the base plane. In this case, the rotary handle relates to any part of an object designed to be grasped and held in a closed hand, particularly the part of an instrument or of a tool enabling it to be held and/or carried. According to the above embodiment, the rotary handle has a large area of contact with the user's hand, transmitting the torque required for locking, thus making it easy to grip and move. Rotational movement around such a rotational axis is particularly ergonomic and intuitive. The rotary handle can be a lever.

The cooking appliance can also have one or more of the following characteristics, taken alone or in combination.

According to one embodiment, the electric food preparation appliance is designed to operate in at least one hot-air cooking mode, thus allowing for a wide variety of cooking methods and a wide variety of foods that can be cooked by the same appliance. The electric food preparation appliance can be designed to comprise a human-machine interface, preferentially in the form of push-buttons, a thumbwheel or a touchscreen, for selecting the cooking mode chosen by the user. The human-machine interface can be connected to a control unit designed to control a processor or microprocessor to run the operation of the cooking actuators chosen by the user.

According to one embodiment, the electric food preparation appliance is designed to enable the hot-air cooking mode irrespective of the position of the locking means. Thus, there is a purely functional aspect of the appliance that would enable the hot-air cooking mode regardless of the position of the locking means, provided that the lid is on the housing, but it could also be foreseen to provide an additional safety feature that would prohibit any cooking mode if the locking means are not in a locked position.

According to one embodiment, the container can be removed from the housing.

According to one embodiment, the appliance comprises internal and/or built-in heating means, typically heating means incorporated into the housing and/or into the lid, to form a “mobile” or “transportable” cooking appliance for connection to a power supply. There is no need for external heating means (hob, hot plate, stove, gas stove).

According to one embodiment, the lid comprises cooking means comprising heating means and/or cooking ventilation means. Combining the cooking means in the lid allows for more room in the housing for the workspace. Coupled at least in part with the cooking ventilation means, the heating means allow for convection cooking. The heating means can be at least one electric coil. The heating means can be provided in the lid and/or under the container and particularly in the housing. Thus, in a hot-air cooking mode, the heating means are distributed around the food to be cooked and the food to be cooked cooks faster and more evenly. According to one embodiment, the heating means comprise air heating means (for example, an electric coil arranged in a gap exposed to or traversed by an air flow when the cooking ventilation means are in operation). According to one embodiment, the heating means comprise container heating means (for example an electric coil arranged under the container and/or near a bottom wall of the container). According to one embodiment, the air heating means are separate and/or separately controllable from the container heating means. According to one embodiment, the air heating means are designed for use in the convection cooking mode. According to one embodiment, the container heating means are designed for use in the pressure cooking mode.

According to one embodiment, the appliance comprises electrical connection or power supply means. A socket, a plug or a power cord can be provided to connect the heating means to a power source.

According to one embodiment, the control interface is arranged on the lid. The control interface is thus easily accessible.

According to one embodiment, the locking means form a bayonet locking system. This assembly relies on the use of container and lid ramps designed to come into sliding mutual support after the lid is rotated, thus ensuring a mechanical retaining connection that keeps the container and the lid from separating under the effect of pressure build-up. Lid ramps are typically produced by locally bending the ring-shaped flanging edge of the lid inwards, whereas container ramps are obtained by bending and trimming the free upper edge of the container. The system is particularly lightweight, reliable and easy to use.

According to one embodiment, the locking means comprise a toothed lock ring arranged in either the lid or the housing to engage with the counter-forms of the other of the lid or of the housing. The housing counter-forms can also be on the container.

According to one embodiment, the locking means comprise retractable jaws.

According to one embodiment, the lid comprises locking means.

According to one embodiment, the rotary handle can be moved between:
a lowered position against the lid, and
a raised position relative to the lid. In other words, the lowered position of the rotary handle corresponds to a first control position of the control interface, and a raised position of the rotary handle corresponds to a second position of the control interface.

According to one embodiment, the lowered position of the rotary handle is configured to define the locked position of the locking means, and the raised position of the rotary handle is configured to define the unlocked position of the locking means.

According to one embodiment, the locking means comprise a transformation device designed to transform a rotational movement of the rotary handle into a translational movement, and preferably to transform the translational movement into a second rotational movement of the locking means.

According to one embodiment, the locking means comprise at least one pinion meshing with a rack. The pinion is driven by the rotational movement of the rotary handle.

According to one embodiment, the rotary handle and/or the rack are arranged at the edge of the lid.

According to one embodiment, the locking means comprise at least one connecting rod and/or a deformable parallelogram.

According to one embodiment, the locking means comprise at least one carriage configured to be moved by the rotary handle and connected to the lock ring, enabling the transformation device to move from a rotation around a first axis to a rotation of the lock ring along another axis.

According to one embodiment, the locking means comprise a slide connection between the carriage and the lock ring, formed, for example, by a drive pin (or finger) mounted on either the carriage or the lock ring, and a slit (or groove or female shape) formed on the other of the carriage and of the lock ring.

According to one embodiment, the carriage is arranged in a slide connection on the lid.

According to one embodiment, rotating the rotary handle drives a first pinion arranged to form a portion of the ring and act as an intermediate meshing. Rotating the first pinion drives the rotation of a second pinion with a different rotational plane and, if necessary, a different pitch diameter from that of the first pinion. The second pinion meshes with the rack.

According to one embodiment, the food preparation appliance comprises a removable inner lid designed to form sealing means to allow for the pressure cooking mode. In fact, the present invention only requires the addition of an extra accessory, such as this inner lid, to the initial device, in order to operate in a pressure cooking mode, thus limiting the space required to store such an appliance. The inner lid is designed to nest in a compartment of the lid that is particularly adapted to accommodate it, preferentially assembled to the lid by sliding levers arranged to cooperate with counter-forms on the lid. The levers can alternatively be replaced by hooks, or elastic tabs, or flexible tabs, or hinged tabs.

According to one embodiment, the locking means comprise holding means designed to hold the lid against the housing. An operation to lock the lid to the housing when the lid is in its closed position requires exerting:
a substantially normal directional force on the base plane on either the lid or the housing toward the other of the lid and the housing,
a substantially normal torque around an axis of direction on the base plane to move the teeth of the lock ring opposite the counter-forms of the container or of the housing. When the lid is held against the housing by the holding means, friction between the teeth of the lock ring and the counter-forms of the housing or of the container is limited. The holding means can be in the form of at least one latch, and/or at least one bolt and/or at least one toggle.

According to one embodiment, the holding means can be moved between a holding position in which the lid is held against the housing in the closed position, and an access position, in which the lid can be moved from the closed position to the open position,
while the control interface can be moved to a third control position in which the holding means are in the access position,
and the second control position is arranged between the third control position and the first control position.

In other words, when the control interface is set to the third position, the lid is in the open position and the holding means are in the access position. When the control interface is set to the second position, the lid is in the closed position and the holding means are in the holding position.

Rotating the rotary handle around an axis parallel to the base plane of the housing takes place as a natural, intuitive movement by the user, who opens the workspace and moves the lid to the open position by raising the rotary handle, similar to the movement used to lift the removable lid of any other cooking vessel, and who closes the workspace by lowering the rotary handle.

By raising the handle, the user unlocks the locking means, releases the holding means and can place or deploy the lid in the open position (a deployed position) in which the workspace is open (accessible), using the same part and performing a similar gesture, thus ensuring the user quick execution and easy handling of the electric food preparation appliance. Lastly, dividing the locking operation of the locking means into two distinct sequences (holding the lid in the closed position with pre-compression of the sealing gasket, for example, and then actuating the locking means themselves according to the positions of the control interface) makes it possible to limit the total effort to be exerted by the user in a single movement. By first keeping the teeth of the lock ring clamped to the housing, the teeth can subsequently position themselves more easily relative to the counter-forms when locking, and the locking operation does not require the user to exert as much effort on the control interface . . . .

According to one embodiment, the locking means comprise moving means for forcing the holding means to move to the access position. These can be a cam, a lever or a connecting rod.

According to one embodiment, the holding means are formed by at least one latch.

According to one embodiment, the locking means are controlled by several control interfaces.

According to one embodiment, the handle axis is parallel to a rotational axis of the lid that defines lid movements between the open position of the lid and the closed position of the lid. According to one embodiment, the lid is attached or connected to the housing by a pivot connection. More specifically, the rotational axis of the lid is the rotational axis of a pivot connection between the housing and the lid, which enables the lid to move from the closed position to the open position and vice versa.

### DESCRIPTION OF THE FIGURES

Other features and advantages of the present invention will become more apparent from the following detailed description of an embodiment of the invention, provided by way of non-limiting example and illustrated in the appended figures, in which:

FIG. 1 shows a general view of an electric food preparation appliance according to the present invention comprising locking means in a locked position;

FIG. 2 shows a general view of an electric food preparation appliance according to the present invention with the locking means in an unlocked position;

FIG. 3 shows a view of the lid of the electric food preparation appliance with the locking means in a locked position;

FIG. 4 shows a view of the lid of the electric food preparation appliance with the locking means in an unlocked position;

FIG. 5 shows a view of the locking mechanism of the means of locking the lid to a housing, in an unlocked position;

FIG. 6 shows a detail of the locking mechanism of the locking means in an unlocked position;

FIG. 7 shows a partial view of the food preparation appliance with alternative locking means;

FIG. 8 shows a partial view of the food preparation appliance with alternative locking means in an unlocked and locked position.

### DETAILED DESCRIPTION OF EMBODIMENT(S)

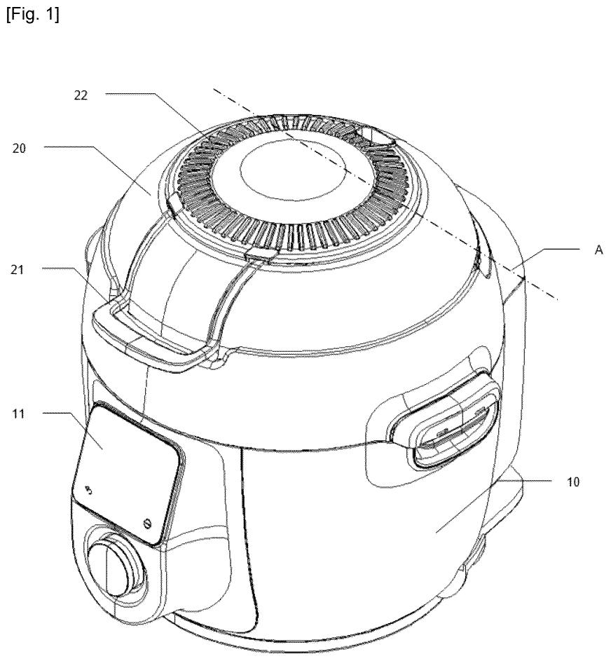

FIG. 1 shows an electric food preparation appliance according to the present invention, comprising a housing 10 designed to hold a container in an inner compartment, for example a removable container, in which the food to be cooked is placed, and to form a workspace. A lid 20 is arranged on the housing 10 to prevent access to or to close the workspace when the lid 20 is in a closed position (as shown in FIG. 1). The lid 20 comprises a control interface featuring a rotary handle 21 designed to be raised or lowered by a user to control a closed or open position of the lid 20. The lid 20 is designed to be connected to the housing 10 by a pivot connection on the lid's rotational axis A parallel to a bottom surface of the housing 10. FIG. 1 also shows a human-machine interface 11 on the housing 10, on which the user can choose a cooking mode, such as a convection cooking mode or a pressure cooking mode. Heating means are provided in the lid 20 and/or under the container to efficiently heat the air in the workspace in a convection cooking mode (in other words, a hot-air cooking mode). The heating means can be coils designed to produce heat by means of an electric current. The lid 20 comprises ventilation means 22 designed to aerate and vent the hot air and/or steam flows in the container generated by food cooking during steam or convection cooking.

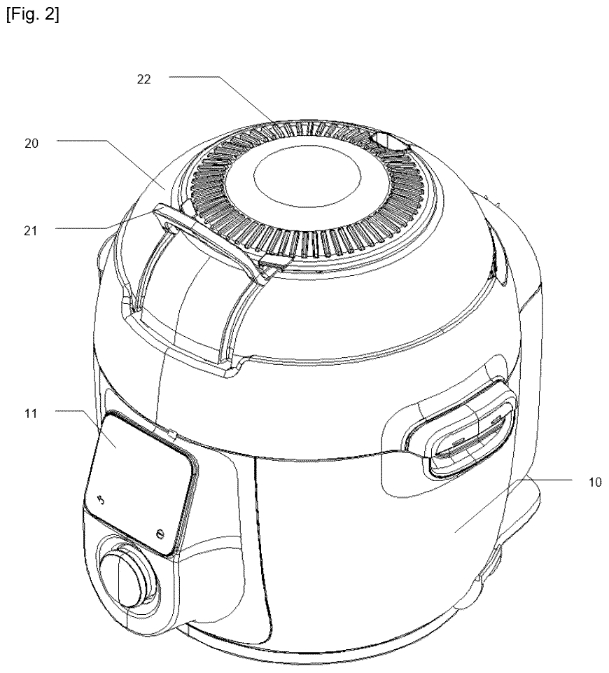

FIG. 2 shows the same food preparation appliance, with the lid 20 in an open position.

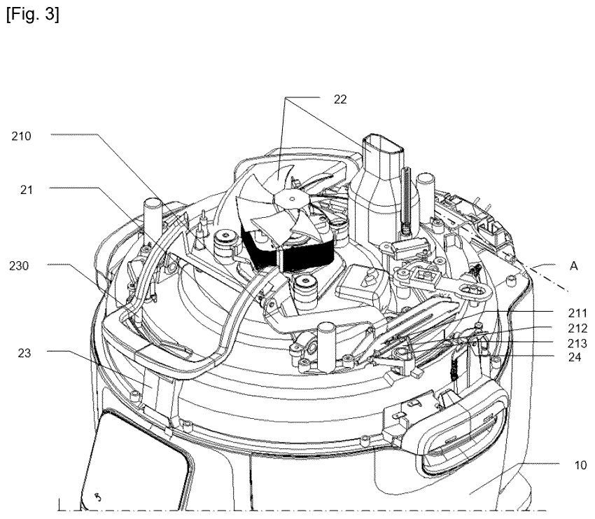

FIG. 3 shows the food preparation appliance with no lid 20 cover. The ventilation means 22 consist of a fan and a vent pipe to clear the steam and hot air flows. Locking means are in a locked position. They comprise a control interface set to a first position, connected on each of its sides by a connecting rod 210 to a slide 211, a carriage 212 attached to the slide 211, and a drive pin 213 mounted on a lock ring (not shown), enabling the teeth of the lock ring to be rotated in order to assemble them to counter-forms on the container or on the housing 10. The lid 20 comprises holding means, themselves comprising a latch 23 and a pin follower 230. The pin follower 230, like the drive pin 213, is mounted on the lock ring and follows a circular path around the edge of the lid 20. To allow for the open position of the lid 20, the pin follower 230 gradually comes up against a cam ramp on the latch 23, causing a lower end of the latch 23 to gradually rotate toward the inside of the lid 20.

A toggle 24 can keep the rotary handle 21 from lowering when the lid 20 is in the open position, particularly when the lid is in the deployed position.

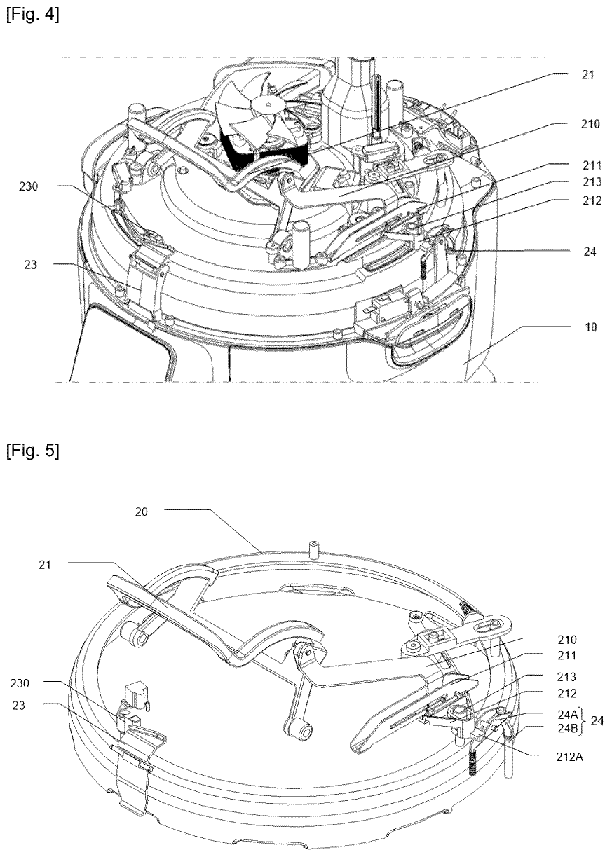

FIG. 4 shows the food preparation appliance with no lid 20 cover, with the locking means in an unlocked position and the control interface in a third position. In this position of the control interface, the carriage 212 and the connecting rod 210 are at the end of their travel in their respective grooves. The pin follower 230 is at the end of its stop on the cam track of latch 23: the latch 23 is in an access position allowing the lid 20 to move from an open position to a closed position and conversely.

FIG. 5 shows a part of the lid 20 comprising a supporting frame designed to be positioned on the container or the housing 10 and locking means in an unlocked position. The rotary handle 21 is designed to be manipulated in a pivoting motion around a handle axis parallel to the bottom surface of the housing 10, so as to drive the connecting rod 210, which is forced to move in the direction imposed by a slide 211 to one of its lug-shaped ends, in a slide groove 211. The lug-shaped end of the connecting rod 210 is joined to the carriage 212 pierced with an oblong hole, in which the drive pin 213 mounted on the lock ring under the lid 20 moves. The carriage 212 moves in a straight line, while the drive pin 213 moves in a circular curve around the lid 20. The pin follower 230 is not at the end of its travel and the holding means are in a holding position. A mechanism for reversing the trajectory could be envisaged, by joining the drive pin 213 to the connecting rod 210; the pin would slide in an oblong hole in the carriage 212 mounted on the lock ring. The lid 20 is in a second position.

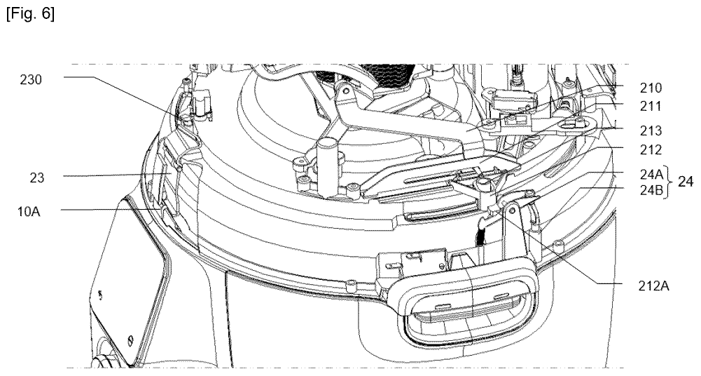

The carriage 212 comprises a tab 212A arranged to follow the movement of the carriage 212 and to wedge into a toggle hook 24 when a plate 24A on the toggle 24 is aligned along a substantially horizontal plane. The toggle 24 comprises a spring that places the plate 24A in a default horizontal plane when the lid 20 is not in contact with the housing 10. Thus, the user can lower the rotary handle 21 only when an upward translational movement of a toggle 24 rod 24B causes the plate 24A to tilt along a plane that is sufficiently sloped relative to the horizontal plane so that the carriage tab 212A can be extracted from the toggle hook 24 (shown in FIG. 6). This upward translational movement takes place when the rod base 24B comes into contact with and bears on an upper surface of the housing 10: the travel of the rod 24B, between the moment when the rod base 24B comes into contact with the housing 10 and the moment when the lid frame 24 comes into contact with the housing 10, is sufficiently long to enable the tab 212A on the toggle 24 to be unhooked. Lastly, the rotary handle 21 is kept from lowering when the lid 20 is in the open position, and when the rod base 24B is not in contact with the housing 10.

FIG. 6 reveals a housing hook 10A on which the lower end of the latch 23 bears when the pin follower 230 is not in contact with the cam track of the latch 23. In fact, return means (not shown), push the latch 23 toward the housing hook 10A when no force is exerted on the latch 23.

Lastly, the sequence of operations carried out to open the lid 20 from a closed position of the lid 20 is as follows:
the user moves the control interface from the first control position to the second control position: the lug on the connecting rod 210 slides a first distance in the slide 211; the lock ring rotates around the lid 20 on an arcuate path and disengages from the housing 10 or from the container; the pin follower 230 also moves the same arcuate path until it reaches the latch cam track 23. The lid 20 is in a closed position when the control interface is in the second control position.
the user moves the control interface from the second control position to the third control position: the connecting rod 210 finishes its travel in the slide 211; the carriage 212 tab 212A is located above the toggle 24 plate 24A after having moved over the toggle hook 24 while the rotary handle 21 was being moved; the pin follower 230 has continued its travel along the latch cam track 23 which has tilted toward the inside of the lid 20 under the thrust of the pin follower 230, detaching itself from the housing hook 10A. The locking means are in the unlocked position and the holding means are in the access position. The lid 20 (in contact with the housing) can move to the open position when the control interface reaches the third control position.
the user freely opens the lid 20 by continuing to move the rotary handle 21 along the same handle axis, so as to place the lid 20 in the open position and access the workspace. When the lid 20 has pivoted sufficiently around the lid rotation axis A, and specifically when the rod base 24B is no longer in contact with the housing 10, the toggle spring 24 relaxes and the toggle hook 24 engages with the carriage tab 212A, so that the control interface is locked in a third position.

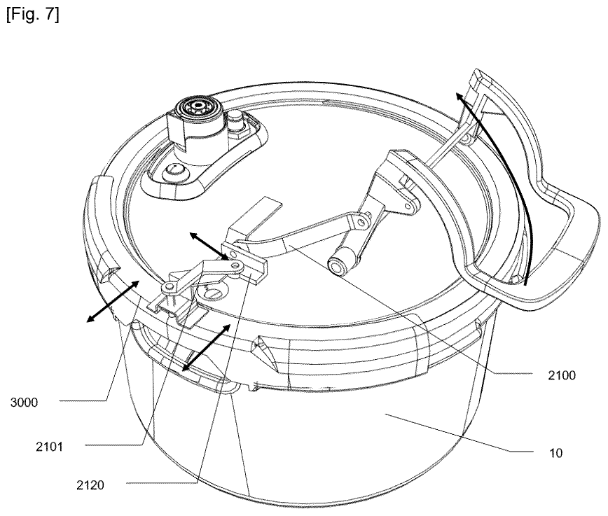

FIG. 7 shows a locking interface according to the present invention coupled to alternative jaw locking means. In this embodiment, the unlocking sequence is as follows:
The user moves the control interface from the first position to the second position. The control interface then pivots around a first axis at one end of a connecting rod 2100.
In doing so, it also pushes an angle bracket 2120 mounted in a pivot connection at the other end of connecting rod 2100. The angle bracket 2120 comprises two sides perpendicular to each other and is itself articulated in two pivot connections on each of its sides, by the connecting rod 2100 on the one hand and another connecting rod 2101 on the other. The two pivot axes are thus orthogonal. The angle bracket 2120 moves in a translational movement, indicated by a double arrow pointing at the angle bracket 2120.
The connecting rod 2101 is pivotally connected to a jaw 3000 on the lid 20. The translational movement of the angle bracket 2120 forces it to move along a translational axis perpendicular to the translational axis of the angle bracket 2120.
The jaw 3000, which in the locked position of the locking means joins the housing 10 to the lid 20, then moves away and enables relative movement of the lid 20 with respect to the housing 10.

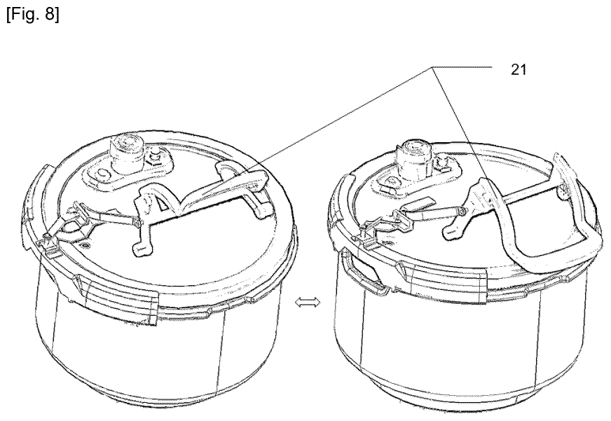

FIG. 8 shows the jaw locking means in their unlocked position with the handle 21 in the raised position on the left; and the jaw locking means in the locked position on the right, with the handle 21 in the lowered position.

### INDUSTRIAL APPLICATION

A food preparation appliance according to the present invention, and the manufacture thereof, are suitable for industrial application.

It will be understood that various modifications and/or improvements that are obvious for the person skilled in the art may be made to the different embodiments of the invention described in this description without departing from the scope of the invention.

In particular, it should be noted that the force transmission mechanisms consisting in transforming a rotation along a first axis into a rotation along a second, different axis, from the rotary handle to the lock ring or lid jaws, may vary.

In particular, it should be noted that the heating means can be coils, but radiant elements, halogen heaters or induction coils can also be used. The heating means can be divided or distributed throughout the appliance: one part housed in the lid, another part housed in the housing. The heating means divided or distributed throughout the appliance can be dedicated: one part housed in the lid for convection cooking (with no pressure), another part housed in the housing for cooking in pressure cooking mode.

1. An electric food preparation appliance configured to operate in a plurality of cooking modes, including at least one pressure cooking mode, comprising:
a housing having a supporting portion configured to rest on a worktop and defining a base plane,
a compartment, disposed in the housing,
a container defining a workspace and configured for holding food for preparing a dish and configured to be accommodated in the compartment in the housing,
a lid, figured to move between a closed position in which access to the workspace is prevented and an open position in which access to the workspace is permitted,
a locking mechanism configured to move between an unlocked position in which the lid can be freely moved between the closed position and the open position, and a locked position in which the lid is locked in the closed position se to enable the at least one pressure cooking mode,
a control interface configured to move between a first control position in which the locking mechanism is in the locked position and a second control position in which the locking mechanism is in the unlocked position,
wherein the control interface comprises a handle that rotates around a handle axis contained in a plane substantially parallel to the base plane.

2. The electric food preparation appliance according to claim 1, wherein the appliance is configured to operate in at least one hot-air cooking mode.

3. The electric food preparation appliance according to claim 2, wherein the appliance is configured to enable the hot-air cooking mode irrespective of a position of the locking mechanism.

4. The electric food preparation appliance according to claim 2, wherein the lid comprises cooking components including a heating element and/or a cooking ventilation mechanism.

5. The electric food preparation appliance according to claim 1, wherein the control interface is disposed on the lid.

6. The electric food preparation appliance according to claim 1, wherein the locking mechanism includes a bayonet locking system.

7. The electric food preparation appliance according to claim 1, wherein the locking mechanism comprises a lock ring.

8. The electric food preparation appliance according to claim 1, wherein the locking mechanism comprises retractable jaws.

9. The electric food preparation appliance according to claim 1, wherein the lid comprises the locking mechanism.

10. The electric food preparation appliance according to claim 1, wherein the rotary handle can be is configured to move between:
a lowered position relative to the lid, and
a raised position relative to the lid.

11. The electric food preparation appliance according to claim 10, wherein the lowered position of the rotary handle is configured to define the locked position of the locking mechanism, and in which the raised position of the rotary handle is configured to define the unlocked position of the locking mechanism.

12. The electric food preparation appliance according to claim 1, wherein the locking mechanism comprises a transformation device configured to transform a rotational movement of the rotary handle into a translational movement.

13. The electric food preparation appliance according to claim 1, wherein the locking mechanism comprises a pinion meshing with a rack.

14. The electric food preparation appliance according to claim 13, wherein the rotary handle and/or the rack are disposed around an edge of the lid.

15. The electric food preparation appliance according to claim 1, wherein the locking mechanism comprises a connecting rod and/or a deformable parallelogram.

16. The electric food preparation appliance according to claim 7, wherein the locking mechanism comprises at least one carriage configured to be moved by the rotary handle and connected to the lock ring.

17. The electric food preparation appliance according to claim 16, wherein the locking mechanism comprises a slide connection between the carriage and the lock ring that includes a drive pin mounted on either the carriage or the lock ring, and a slit disposed on the other of the carriage and the lock ring.

18. The electric food preparation appliance according to claim 167, wherein the carriage is arranged in the slide connection on the lid.

19. The electric food preparation appliance according to claim 1, comprising a removable inner lid configured to form a seal to allow for the pressure cooking mode.

20. The electric food preparation appliance according to claim 1, wherein the locking mechanism comprises a holding mechanism configured to hold the lid against the housing.

21. The electric food preparation appliance according to claim 20, wherein the holding mechanism is configured to move between a holding position in which the lid is held against the housing, and an access position, in which the lid can freely moved between the closed position and the open position,
wherein the control interface is configured to move to a third control position in which the holding mechanism is in the access position,
and wherein the second control position is arranged between the third control position and the first control position.

22. The electric food preparation appliance according to claim 20, wherein the locking mechanism comprises an actuating component configured to move the holding mechanism.

23. The electric food preparation appliance according to claim 20, wherein the holding mechanism includes a latch.
